(19) United States
(12) Patent Application Publication
(10) Pub. No.: US 2007/0253202 A1
(43) Pub. Date: Nov. 1, 2007

(54) LED lamp and heat-dissipating structure thereof

(75) Inventors: Chung Wu, Taipei (TW); Meng-Cheng Huang, Taipei (TW); Zu-Chao Hsu, Taipei (TW)

Correspondence Address: HDSL, 4331 STEVENS BATTLE LANE, FAIRFAX, VA, 22033, US

(73) Assignee: Chaun-Choung Technology Corp.

(21) Appl. No.: 11/413,089

(22) Filed: Apr. 28, 2006

(51) Int. Cl. F21V 29/00

(52) U.S. Cl. 362/294

(57) ABSTRACT

The present invention is directed to a LED lamp and the heat-dissipating structure thereof. The heat-dissipating structure is used to dissipate the heat generated by the LED and comprises a first heat-dissipating body and a second heat-dissipating body. The first heat-dissipating body has a casing with an opening formed thereon. The second heat-dissipating body is connected on the first heat-dissipating body and comprises at least one heat pipe and a plurality of heat-dissipating fins connected to the heat pipe. With this arrangement, the LED continuously operates under a suitable working temperature and the life of the LED can thus be prolonged.

### BACKGROUND OF THE INVENTION

1. Field of the Invention

The present invention relates to a LED lamp and a heat-dissipating structure thereof, and in particular to a LED lamp for illuminating and a heat-dissipating structure for transferring and dissipating the heat generated by the light emitting diode (LED).

2. Description of Prior Art

Since the LED has many advantages such as high-illumination, energy-saving and long-life etc., it is widely applied to the illumination of the electronic devices or lamps. Further, in order to increase the illuminating region and the intensity of the light of the LED, a plurality of LEDs are usually assembled together to form a LED lamp. However, with the increase in the number of the assembled LEDs and the continuous developments of the high-power LEDs, the heat generated by such LEDs is gradually increasing accordingly. Therefore, it is an important issue for those engaged in this art to provide a LED lamp that has a heat-dissipating structure and can be assembled and manufactured easily.

A conventional LED lamp, as disclosed in Taiwan Patent Application No. 94205809, mainly comprises a heat-dissipating structure, a light-emitting module and a lamp head. In this patent document, the heat-dissipating structure comprises a heat-dissipating module and a heat-conducting liquid. The heat-dissipating module has a lamp chamber. On both ends of the heat-dissipating module, the lamp chamber is formed with a first opening and a second opening, respectively. Between the first opening and the second opening, a sealed chamber is provided on the heat-dissipating module. The heat-conducting liquid is filled within the sealed chamber. The light-emitting module is provided on the second opening of the heat-dissipating module. Further, the lamp head covers on the heat-dissipating module of the light-emitting module to form a LED lamp. With the above arrangement, the heat generated by the light-emitting module can be transferred and dissipated.

However, in practice, conventional LED lamps still have the following disadvantages. Since the heat-dissipating module of the LED lamp aims to transfer and dissipate the heat generated in the front of the light-emitting module, the heat generated in the back of the light-emitting module cannot be effectively and quickly transferred to the outside. The amount of heat to be transferred is greatly limited, so that a relatively great amount of heat is accumulated in the back of the light-emitting module, causing the shortening of the life of the LED in the light-emitting module and the rapid aging and damage of the peripheral components. Further, the sealed chamber is formed by assembling the heat-dissipating module and a lamp cover, so that the manufacturing procedure of the sealing connection is very complicated. After heating, the heat-conducting liquid within the chamber generates high temperature and high pressure, which makes the heat-conducting liquid to escape from the connection portion between the heat-dissipating module and the lamp cover more easily.

Therefore, in view of the above the drawbacks, the inventor proposes the present invention entitled “LED Lamp and Heat-Dissipating Structure Thereof” to overcome the above problems based on his expert experiences and deliberate researches.

### SUMMARY OF THE INVENTION

The present invention is to provide a heat-dissipating structure of a LED lamp, by which the LED can be continuously operated under a suitable working temperature and the life of the LED can thus be prolonged.

The present invention is directed to a heat-dissipating structure of a LED lamp for dissipating the heat generated by the LED. The heat-dissipating structure of the present invention comprises a first heat-dissipating body and a second heat-dissipating body. The first heat-dissipating body has a casing with an opening formed formed. The second heat-dissipating body is connected on the first heat-dissipating body and comprises at least one heat pipe and a plurality of heat-dissipating fins connected to the heat pipe.

Another, the present invention is to provide a LED lamp. With the simple assembling of all constituent elements, the manufacturing procedure can be greatly simplified and the assembling time and the cost in labor hour can be reduced.

The present invention is directed to a LED lamp comprising a heat-dissipating structure, at least one LED and a lamp head. The heat-dissipating structure comprises a first heat-dissipating body and a second heat-dissipating body. The first heat-dissipating body has a casing with an opening formed thereon. The second heat-dissipating body is connected on the first heat-dissipating body and comprises at least one heat pipe and a plurality of heat-dissipating fins connected to the heat pipe. A line-accommodating portion is provided on each heat-dissipating fin. The LED is accommodated within the casing of the first heat-dissipating body. The lamp head has a threaded terminal and an insulating cover connected to the underside of the threaded terminal. The interior of the threaded terminal is provided with two power supply lines each passing through the line-accommodating portion of each heat-dissipating fin to be electrically connected to the LED. The insulating cover covers the outside of the second heat-dissipating body and connected on the first heat-dissipating body.

### BRIEF DESCRIPTION OF THE DRAWINGS

FIG. 1 is an exploded perspective view of the first and second heat-dissipating body of the present invention;

FIG. 2 is an exploded perspective view of the second heat-dissipating body of the present invention;

FIG. 3 is an exploded perspective view of the heat-dissipating structure and the lamp head assembly of the present invention;

FIG. 4 is a schematic view showing the assembling of the heat-dissipating structure and the lamp head assembly of the present invention;

FIG. 5 is a longitudinal cross-sectional view of FIG. 4;

FIG. 6 is a lateral cross-sectional view of FIG. 4;

FIG. 7 is a cross-sectional view showing the assembling of another embodiment of the second heat-dissipating body of the present invention;

FIG. 8 is a schematic view showing the assembling of another embodiment of the LED lamp of the present invention; and

FIG. 9 is a lateral cross-sectional view of FIG. 8.

### DETAILED DESCRIPTION OF THE INVENTION

The detailed description and the technical contents of the present invention will be explained with reference to the accompanying drawings. However, it should be understood that the drawings are illustrative but not used to limit the scope of the present invention.

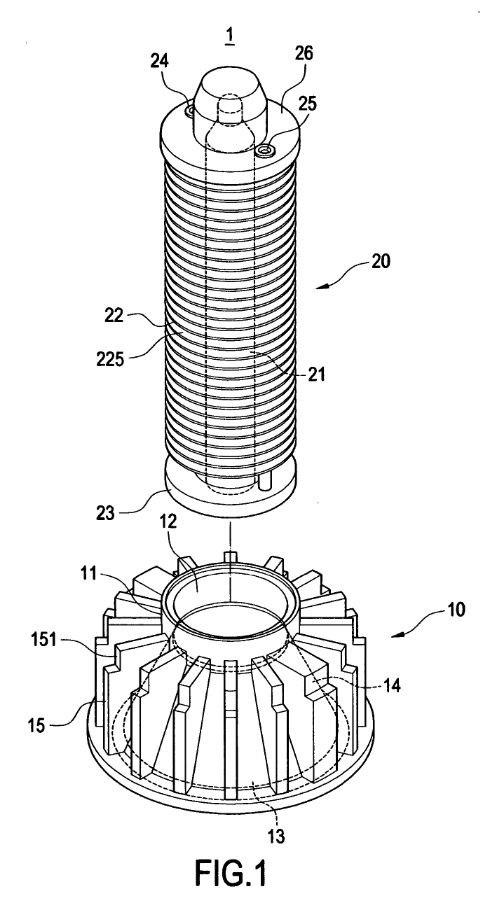

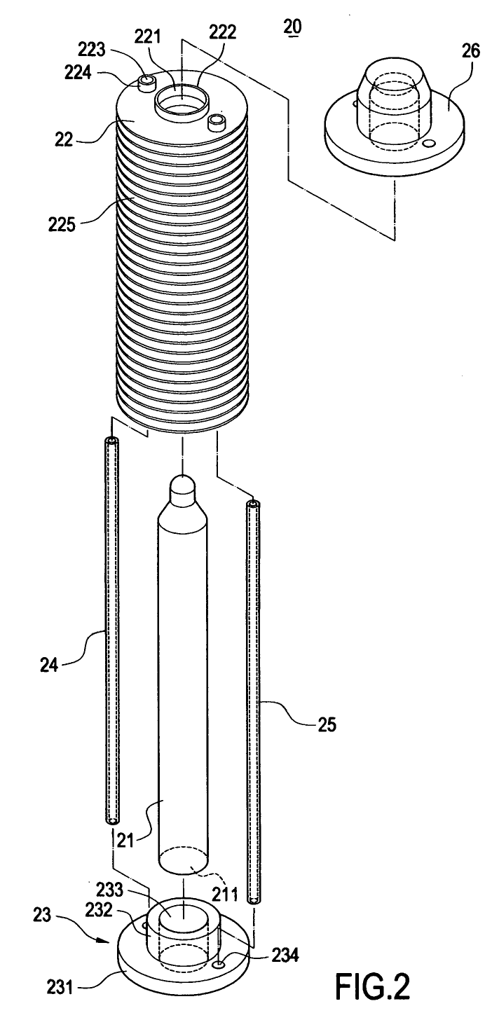

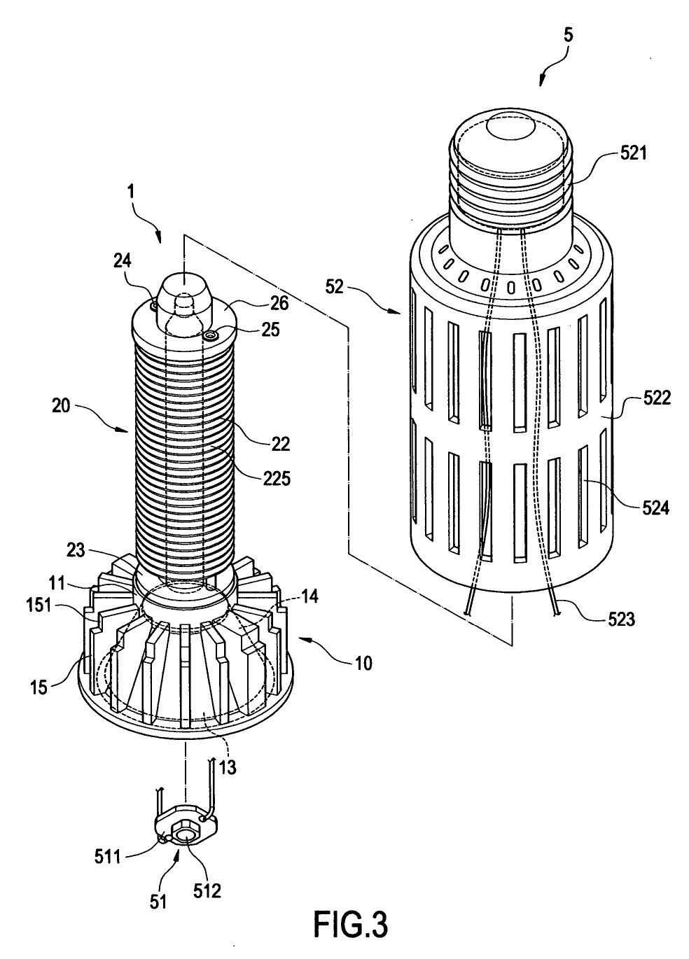

With reference to FIGS. 1 and 2, FIG. 1 is an exploded perspective view of the first and second heat-dissipating body of the present invention, and FIG. 2 is an exploded perspective view of the second heat-dissipating body of the present invention. The present invention provides a LED lamp and the heat-dissipating structure thereof. The LED lamp mainly comprises a heat-dissipating structure 1 and a lamp head assembly 5 (as shown in FIG. 3).

The heat-dissipating structure 1 comprises a first heat-dissipating body 10 and a second heat-dissipating body 20. The first heat-dissipating body 10 has a conical casing 11. The casing 11 can be made of suitable materials having excellent heat conductivity such as aluminum by extrusion or press molding. On the upper and lower sides of the casing, two circular openings 12, 13 are formed respectively. Between the openings 12 and 13 and inside the casing 11, a light-reflecting material is coated to form a reflecting surface 14. Further, a plurality of radial heat-dissipating pieces 15 project outwardly from the outer periphery of the casing 11. The top of each heat-dissipating piece 15 is formed with a stepped connecting section 151, respectively.

The second heat-dissipating body 20 is connected on the first heat-dissipating body 10 and comprises a heat pipe 21, a plurality of heat-dissipating fins 22, a fixing base 23, two positioning tubes 24, 25 and a mask 26. The heat pipe 21 is formed into an “I-lettered” shape. The bottom of the heat pipe has a plane 211, and the interior thereof is filled with a capillary structure and a working fluid. The center of each heat-dissipating fin 22 is provided with a through hole 221. An annular wall 222 extends upwardly from the periphery of the through hole 221. Both left and right sides of the through hole 221 is formed with a line-accommodating portion 223, respectively. In the present embodiment, the line-accommodating portion 223 is a through hole having an annular wall 224 extended upwardly in the periphery thereof. The heat-dissipating pieces 22 are set to superpose on one another. The top surface of each annular wall 222 or 224 is brought into contact with the bottom surface of the adjacent heat-dissipating fin 22. A heat-dissipating flowing path 225 is formed between two adjacent heat-dissipating fins 22.

The fixing base 23 has a first annular body 231 and a second annular body 232 extending upwardly from the first annular body 231. A through hole 233 is formed in the center of the first annular body 231 and the second annular body 232. Further, two fixing holes 234 are provided on the first annular body 231. The through hole 233 is adapted to be inserted by the heat pipe 21 with the end bearing the plane 211. The fixing holes 234 are adapted to be inserted by the positioning tubes 24 and 24, respectively. The heat pipe 21 and the other end of the positioning tubes 24, 25 are sequentially connected to the through hole 221 of each heat-dissipating fin 22 and the line-accommodating portion 223. Then, the mask 26 covers on the heat pipe 21, the heat-dissipating fins 22 and the positioning pipes 24, 25, so that the distal end of each positioning tube 24, 25 projects upwardly beyond the outside of the mask 26. Similarly, the positioning tubes 24, 25 are fixed on the mask 26 in such a manner that each heat-dissipating fin 22 is clamped and positioned between the fixing base 23 and the mask 26.

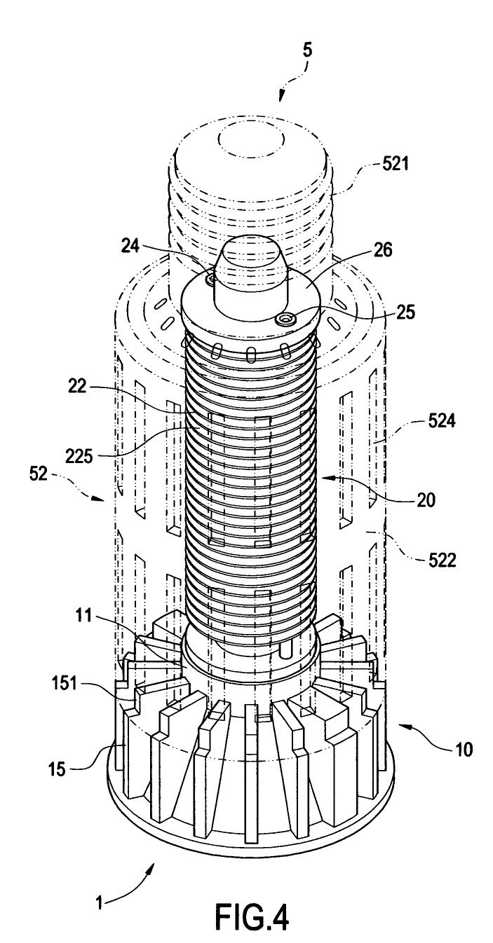

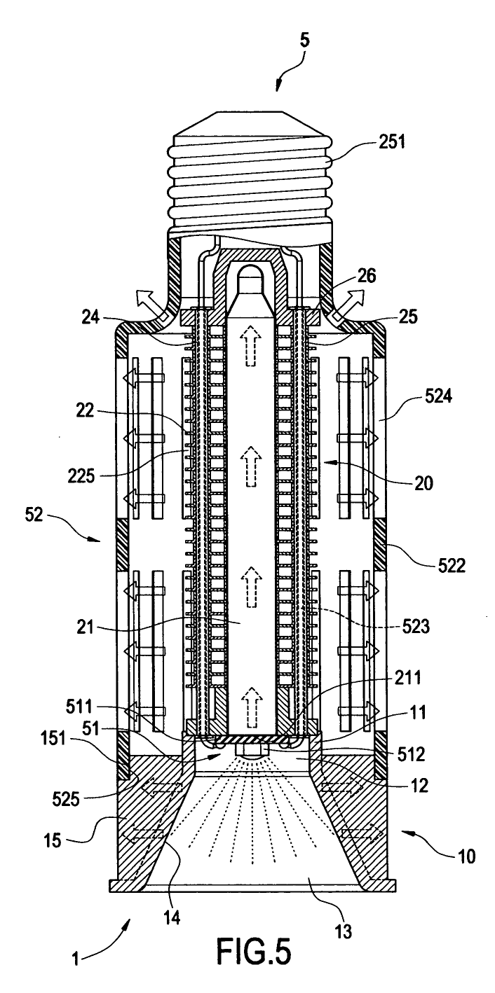

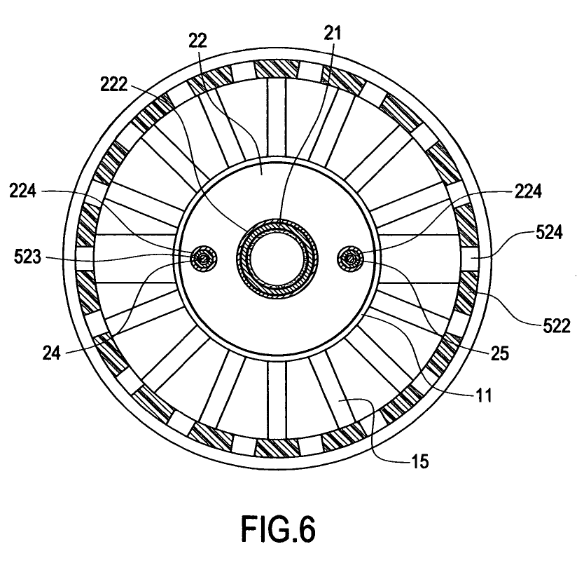

With reference to FIGS. 3 to 6, FIG. 3 is an exploded perspective view of the heat-dissipating structure and the lamp head assembly of the present invention, and FIG. 4 is a schematic view showing the assembling of the heat-dissipating structure and the lamp head assembly of the present invention. FIG. 5 is a longitudinal cross-sectional view of FIG. 4, and FIG. 6 is a lateral cross-sectional view of FIG. 4. The lamp head assembly 5 comprises a light-emitting module 51 and a lamp head 52. The light-emitting module 51 has a circuit board 511 and a LED 512 connected to the circuit board 511. The lamp head 52 has a threaded terminal 521 and an insulating cover 522 connected to the underside of the threaded terminal 521. Two power supply lines 523 are provided within the threaded terminal 521. At the periphery of the insulating cover 522, a plurality of longitudinal venting grooves 524 are provided orderly to correspond to the heat-dissipating flowing path 225 of each heat-dissipating fin 22. The inside surface of the bottom end of the insulating cover 522 is formed with a connecting section 525 for correspondingly connecting to the connecting section 151 of the first heat-dissipating body 10.

The assembling procedure of the present invention will be described in the following.

First, the circuit board 511 of the light-emitting module 51 abuts against the bottom surface of the fixing base 23 of the second heat-dissipating body 20, so that the back of the LED 512 is exactly brought into contact with the plane 211 of the heat pipe 21. Then, each lead connecting to the circuit board 511 of the light-emitting module 51 is set to pass through the interior of the positioning tubes 24, 25 and project from the upside of the positioning tubes 24, 25. The leads are electrically connected to each power supply line 523 of the lamp head 52 to achieve the electrical connection between the lamp head 52 and the light-emitting module 51. Further, in order to achieve the tight contact between the circuit board 511 and the heat pipe 21, a heat-conducting medium (not shown) can be coated therebetween. Finally, the connecting section 151 of the first heat-dissipating body 10 is correspondingly connected to the connecting section 525 of the insulating cover 522, so that the light-emitting module 51 is correspondingly provided in the upper opening 12 of the first heat-dissipating body 10. The heat generated by the LED 512 is dissipated via the first heat-dissipating body 10 and the second heat-dissipating body 20, so that the LED 512 can be continuously operated under a suitable working temperature and thus its life is prolonged.

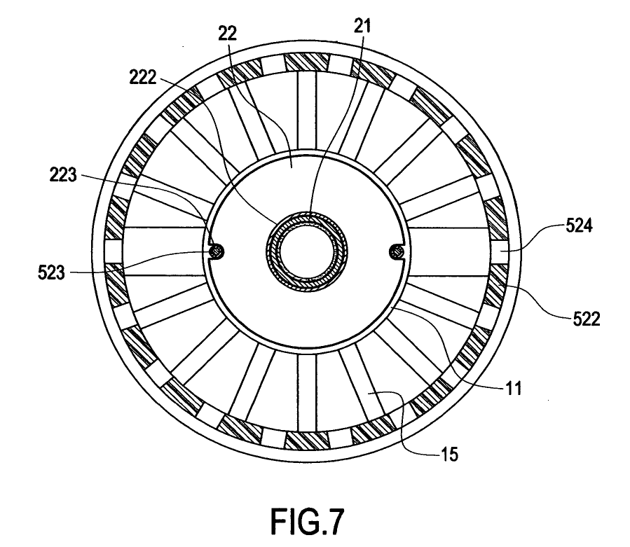

With reference to FIG. 7, FIG. 7 is a cross-sectional view showing the assembling of another embodiment of the second heat-dissipating body of the present invention. In addition to the above embodiment, each heat-dissipating fin 22 of the second heat-dissipating body 20 can also adopt the profile as shown in this embodiment. At the periphery of each heat-dissipating fin 22, two recessed line-accommodating portions 223 are provided to correspond to each other. In the present embodiment, the line-accommodating portion 223 is a recessed groove. The power supply line 523 of the lamp head 52 can be inserted and thus fixed in each recessed groove, and then is electrically connected to the circuit board 511 of the light-emitting module 51.

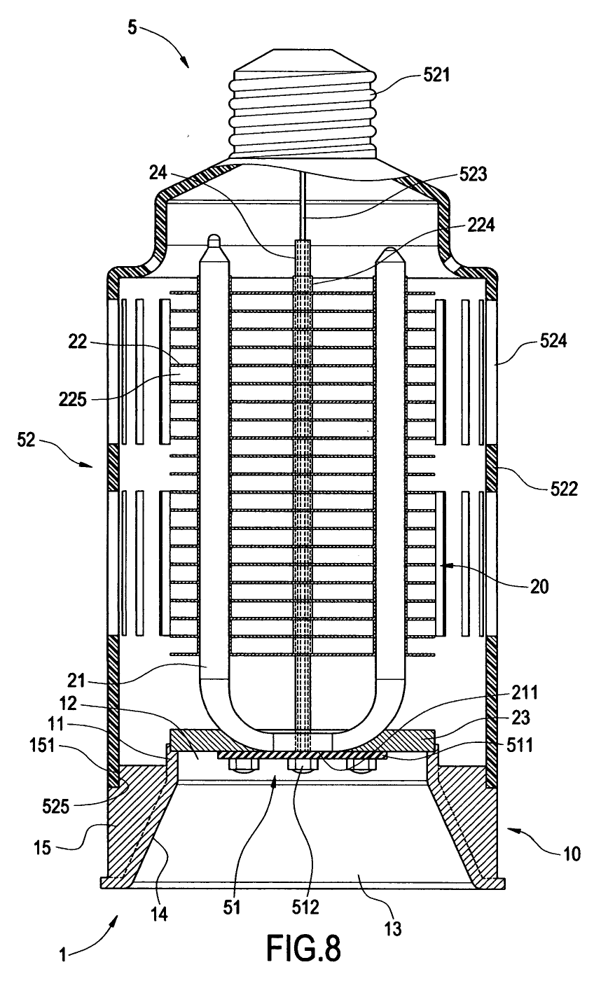

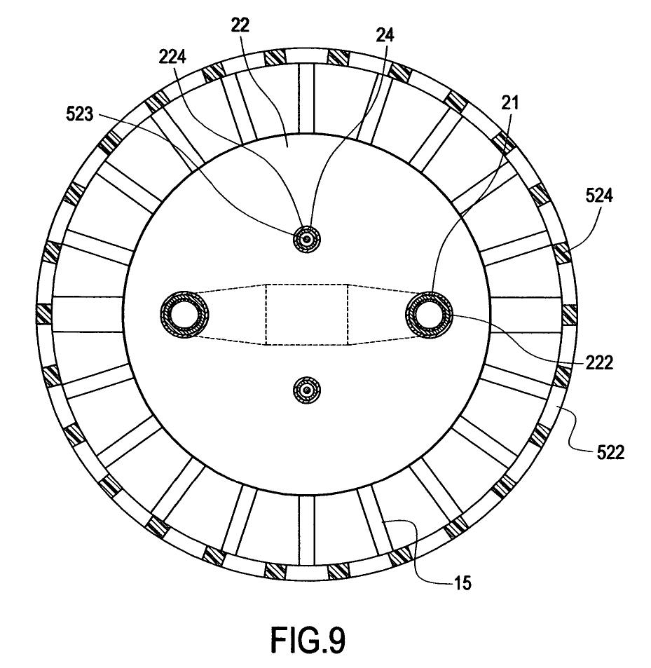

With reference to FIGS. 8 and 9, FIG. 8 is a schematic view showing the assembling of another embodiment of the LED lamp of the present invention, and FIG. 9 is a lateral cross-sectional view of FIG. 8. In additional to the above embodiment, the heat pipe 21 of the second heat-dissipating body 20 can be variously designed corresponding to the different amount of heat generated by various light-emitting modules 51. The heat pipe 21 can be formed into an “U-lettered” or “L-lettered” shape (not shown). Further, a plurality of the heat pipes may be provided (not shown) to increase the heat-conducting rate of the second heat-dissipating body 20, so that such arrangement is suitable for a high-power LED 512.

According to the above, the LED lamp and its heat-dissipating structure of the present invent indeed achieve the desired effects by employing the above structures. Further, since the construction of the present invention has not been published or put to public use prior to applying for patent, the present invention involves the novelty and inventive steps, and conforms to the requirements for a utility model patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A heat-dissipating structure of a LED lamp for dissipating the heat generated by the LED, comprising a first heat-dissipating body and a second heat-dissipating body, wherein the first heat-dissipating body has a casing with an opening formed thereon, and the second heat-dissipating body is connected on the first heat-dissipating body and comprises at least one heat pipe and a plurality of heat-dissipating fins connected to the heat pipe.

2. The heat-dissipating structure of a LED lamp according to claim 1, wherein a plurality of radial heat-dissipating pieces project from the outside of the casing of the first heat-dissipating body.

3. The heat-dissipating structure of a LED lamp according to claim 1, wherein a reflecting surface is formed inside the casing of the first heat-dissipating body.

4. The heat-dissipating structure of a LED lamp according to claim 1, wherein the heat pipe of the second heat-dissipating body is formed into any one of “I-lettered”, “L-lettered” and “U-lettered” shapes.

5. The heat-dissipating structure of a LED lamp according to claim 4, wherein the bottom of the heat pipe of the second heat-dissipating body is provided with a plane.

6. The heat-dissipating structure of a LED lamp according to claim 1, wherein each heat-dissipating fin is provided with a through hole, an annular wall extends upwardly from the periphery of the through hole, both sides of the through hole are provided with a penetrating hole, and an annular wall extends upwardly from the periphery of the penetrating hole.

7. The heat-dissipating structure of a LED lamp according to claim 6, wherein each heat-dissipating fin is set to superpose on one another, the top surface of each annular wall is brought into contact with the bottom surface of the adjacent heat-dissipating fin, and a heat-dissipating flowing path is formed between any two adjacent heat-dissipating fins.

8. The heat-dissipating structure of a LED lamp according to claim 6, wherein the second heat-dissipating body further comprises a fixing base and two positioning tubes, the fixing base is provided with a through hole and a fixing hole for being inserted by the heat pipe and one end of the positioning tube, respectively, and the heat pipe and the other end of each positioning tube is connected to the through hole and the penetrating hole of each heat-dissipating fin, respectively.

9. The heat-dissipating structure of a LED lamp according to claim 8, wherein the second heat-dissipating body further comprises a cover for covering on the heat pipe, the heat-dissipating fins and each positioning tube, so that each heat-dissipating fin is sandwiched and positioned between the fixing base and the cover.

10. A LED lamp, comprising:
a heat-dissipating structure comprising a first heat-dissipating body and a second heat-dissipating body, the first heat-dissipating body having a casing with an opening formed thereon, the second heat-dissipating body connected on the first heat-dissipating body and comprising at least one heat pipe and a plurality of heat-dissipating fins, and a line-accommodating portion provided on each heat-dissipating fin;
at least one LED accommodated within the casing of the first heat-dissipating body; and
a lamp head having a threaded terminal and an insulating cover connected to the underside of the threaded terminal, two power supply lines connected to the interior of the threaded terminal, each power supply line passing through the line-accommodating portion of each heat-dissipating fin to be electrically connected to the LED, and the insulating cover covering the outside of the second heat-dissipating body and connected on the first heat-dissipating body.

11. The LED lamp according to claim 10, wherein a plurality of radial heat-dissipating pieces project from the outside of the casing of the first heat-dissipating body.

12. The LED lamp according to claim 10, wherein a reflecting surface is formed inside the casing of the first heat-dissipating body.

13. The LED lamp according to claim 10, wherein the heat pipe of the second heat-dissipating body is formed into any one of “I-lettered”, “L-lettered” and “U-lettered” shapes.

14. The LED lamp according to claim 10, wherein each heat-dissipating fin is provided with a through hole, an annular wall extends upwardly from the periphery of the through hole, both sides of the through hole are provided with the line-accommodating portions, each line-accommodating portion is a penetrating hole, and an annular wall extends upwardly from the periphery of the penetrating hole.

15. The LED lamp according to claim 14, wherein each heat-dissipating fin is set to superpose on one another, the top surface of each annular wall is brought into contact with the bottom surface of the adjacent heat dissipating fin, and a heat-dissipating flowing path is formed between any two adjacent heat-dissipating fins.

16. The LED lamp according to claim 15, wherein the periphery of the insulating cover of the lamp head is provided with a plurality of venting grooves to correspond to the heat-dissipating flowing path of each heat-dissipating fin.

17. The LED lamp according to claim 14, wherein the second heat-dissipating body further comprises a fixing base and two positioning tubes, the fixing base is provided with a through hole and a fixing hole for being respectively inserted by the heat pipe and one end of the positioning tube, the heat pipe and the other end of each positioning tube is respectively connected to the through hole and the penetrating hole of each heat-dissipating fin, and each power supply line of the lamp head passes through the interior of each positioning tube.

18. The LED lamp according to claim 17, wherein the second heat-dissipating body further comprises a cover for covering on the heat pipe, the heat-dissipating fins and each positioning tube, so that each heat-dissipating fin is sandwiched and positioned between the fixing base and the cover.

19. The LED lamp according to claim 10, wherein the periphery of each heat-dissipating fin is recessed inwardly to provide the line-accommodating portion, and the line-accommodating portion is a recessed groove for being inserted by each power supply line of the lamp head.

20. The LED lamp according to claim 10, further comprising a circuit board for connecting to the LED, and the back of the circuit board abutting against the heat pipe of the second heat-dissipating body.
